(19) United States
(12) Patent Application Publication
(10) Pub. No.: US 2015/0131399 A1
(43) Pub. Date: May 14, 2015

(54) SYSTEMS AND METHODS OF REGULATING TEMPERATURE OF A SOLID-STATE SHEAR PULVERIZATION OR SOLID-STATE MELT EXTRUSION DEVICE

(71) Applicant: Zzyzx Polymers LLC, Allentown, PA (US)

(72) Inventors: Philip BRUNNER, East Stroudsburg, PA (US); Mark TAPSAK, Orangeville, PA (US)

(21) Appl. No.: 14/537,283

(22) Filed: Nov. 10, 2014

Related U.S. Application Data
(60) Provisional application No. 61/903,389, filed on Nov. 12, 2013.

(51) Int. Cl. B29C 47/60; B29B 7/82; B29B 7/46; B29C 47/84

(52) U.S. Cl. CPC B29C 47/6006; B29C 47/847; B29C 47/842; B29B 7/823; B29B 7/46
USPC 366/83; 366/79

(57) ABSTRACT

Systems and methods for controlling the temperature of a solid-state screw extruder may include providing an extrusion screw that incorporates one or more screw shaft channels. The shaft channels may be configured to conduct a flow of a heat conducting medium along a length of the shaft. The shaft channels may be incorporated into an exterior surface or within the body of the screw shaft. The extruder may include extrusion screw elements in mechanical communication with the shaft. Each of the elements may further include one or more element channels also configured to conduct a flow of the medium. The shaft channels and the element channels may be disposed to permit a flow of the medium therebetween. The temperature of the extrusion screws and/or screw elements may be controlled by circulating the medium from a source, through the shaft and element channels, and back to the source.

### CLAIM OF PRIORITY

This application claims benefit of and priority to U.S. Provisional Application No. 61/903,389 entitled “Screw Design for Solid-State Shear Pulverization or Solid-State Melt Extrusion” filed Nov. 12, 2013, the disclosure of which is incorporated by reference herein in its entirety.

### BACKGROUND

Although twin-screw extrusion (TSE) has long been established as one of the most prominent techniques for processing homopolymers, copolymers, and polymer blends from virgin and/or recycled sources as well as polymer composites and/or nanocomposites, the shear mixing in TSE is often not sufficiently rigorous to create a homogenous material in polymer blends or exfoliate (separate) and/or disperse (spread) the fillers in composites and/or nanocomposites. In addition, a long period of exposure to high temperature conditions in TSE can lead to thermal degradation of the materials. These limitations often render TSE ineffective for producing high-performance polymer blends, composites and/or nanocomposites.

Solid-state shear pulverization (SSSP) and solid-state melt-extrusion (SSME) techniques achieve better dispersion of heterogeneous nucleating agents in homopolymers, mixing of immiscible polymer blends, and better exfoliation and/or dispersion in polymer composite and/or nanocomposite systems relative to TSE. The SSSP and SSME production rate can be further improved with modification to the apparatus.

A need exists for modifications to these extrusion approaches that can achieve good mixing, exfoliation and/or dispersion in homopolymers, polymer blends and composites and/or nanocomposites at improved throughput rates.

### SUMMARY

In an embodiment, an extrusion screw assembly for a solid state screw extruder may include at least one extrusion screw shaft, and at least one extrusion screw element in mechanical communication with the at least one extrusion screw shaft, in which the at least one extrusion screw shaft is composed of at least one extrusion shaft channel along at least a portion of a length of the at least one extrusion screw shaft, and in which the at least one extrusion shaft channel is configured to transfer a heat transfer medium.

In an embodiment, a method of controlling a temperature of a solid state screw extruder may include providing a screw extruder, causing a heat transfer medium to flow from a source of the heat transfer medium through an at least one extrusion shaft channel, causing an at least one extrusion screw element to form a thermal contact with the heat transfer medium flowing through the at least one extrusion shaft channel, and controlling, by a temperature controller, a temperature of one or more of the at least one extrusion shaft and the at least one extrusion screw element. The screw extruder may include an extrusion screw assembly, the source of the heat transfer medium, and the temperature controller configured to control the temperature of the heat transfer medium. The extrusion screw assembly may further include the at least one extrusion screw shaft and the at least one extrusion screw element in mechanical communication with the at least one extrusion screw shaft, in which the at least one extrusion screw shaft includes the at least one extrusion shaft channel along at least a portion of a length of the at least one extrusion screw shaft, and in which the at least one extrusion shaft channel is configured to transfer the heat transfer medium.

In an embodiment, a method of dispersing materials in a polymer composition may include providing a screw extruder, causing a heat transfer medium to flow from a source of the heat transfer medium through an at least one extrusion shaft channel, causing an at least one extrusion screw element to form a thermal contact with the heat transfer medium flowing through the at least one extrusion shaft channel, controlling, by a temperature controller, a temperature of one or more of the at least one extrusion shaft and the at least one extrusion screw element via the heat transfer medium, introducing a polymeric mixture into the screw extruder, solid-state shearing the polymeric mixture in an initial zone of the screw extruder to yield a dispersal material in which the temperature of one or more of the at least one extrusion shaft and the at least one extrusion screw element within the initial zone has a temperature less than or equal to a liquefication temperature of the polymeric mixture, and dispensing the dispersal material from the screw extruder. The screw extruder may include an extrusion screw assembly, the source of the heat transfer medium, and the temperature controller configured to control the temperature of the heat transfer medium. The extrusion screw assembly may further include the at least one extrusion screw shaft and the at least one extrusion screw element in mechanical communication with the at least one extrusion screw shaft, in which the at least one extrusion screw shaft includes the at least one extrusion shaft channel along at least a portion of a length of the at least one extrusion screw shaft, and in which the at least one extrusion shaft channel is configured to transfer the heat transfer medium.

### BRIEF DESCRIPTION OF THE DRAWINGS

FIG. 1 illustrates a solid-state shear pulverizer (SSSP) screw assembly in accordance with some embodiments.

FIG. 2 illustrates a solid-state melt extruder (SSME) screw assembly in accordance with some embodiments.

FIG. 3A illustrates the flow of a heat transfer medium between a surface of a screw shaft and a surface of a screw element in accordance with some embodiments.

FIG. 3B illustrates a longitudinal view of a screw shaft having a surface channel and a plurality of screw elements each having an element channel, the channels configured to conduct a heat transfer medium in accordance with some embodiments.

FIGS. 3C and 3D illustrate a cross-sectional view of a screw shaft having a plurality of surface channels and a screw element having a plurality of element channels, respectively, the channels configured to conduct a heat transfer medium in accordance with some embodiments.

FIG. 3E illustrates a rotary union in accordance with some embodiments.

FIG. 4 illustrates a screw shaft and a screw element having a thermal grease disposed therebetween in accordance with some embodiments.

FIG. 5 illustrates a screw element welded to a screw shaft in accordance with some embodiments.

FIGS. 6A and 6B illustrate a screw shaft having an internal channel for conducting a flow of a heat transfer medium in accordance with some embodiments.

FIG. 6C illustrates a screw shaft having an internal channel for conducting a flow of a heat transfer medium into internal element channels of one or more screw elements in accordance with some embodiments.

FIG. 7 is a flow chart of an embodiment of a method of controlling a temperature of a screw extruder.

FIG. 8 is a flow chart of an embodiment of a method of dispersing materials in a polymer composition.

### DETAILED DESCRIPTION

As used herein, the term “screw element” refers to an article in any form, shape, or combination thereof. Non-limiting examples of shapes include monolobe, bilobe, trilobe, quadralobe, pentalobe, etc. Furthermore, any of the above screw elements can function as forward, neutral, or reverse and be used for kneading, mixing, pulverization, or conveying polymers and compounds. The screw elements can comprise metals in whole or part. In addition, the screw element may be clad, layered or solid.

As used herein, the term “screw shaft” refers to an article in any form, shape or combination thereof. Non-limiting examples of cross-sectional shapes of a screw shaft may include hexagonal, rectangular, triangular, pentagonal, octagonal, spline, and round cross-sections. The shaft can also be threaded or unthreaded, bored to any length or unbored, and of any overall length. The screw shaft can comprise metals in whole or part. In addition the screw shaft may be clad, layered or solid.

The term “metal” as used herein, refers to the material that makes up the screw shaft and/or screw element. Non-limiting examples of metals include iron, copper, nickel, niobium, molybdenum, vanadium, chromium, titanium, calcium, rare earth elements, zirconium, stainless steel, a corrosion resistant high performance alloy, Cr Steel, Nitriding steel, carbon steel, spring steel, alloy steel, maraging steel, weathering steel, tool steel, and a high isotactic pressing (HIP) treated material. The term metal also refers to alloys comprising any combination of metals previously described.

As used herein, the term “thermal grease” refers to heat transfer media that increases heat transfer between screw shaft and screw elements. Non-limiting examples of thermal grease include electrically non-conductive, silicone and zinc thermal greases, and electrically conductive, silver, copper, and aluminum-based greases.

As used herein, the term “heat transfer media” refers to materials that are useful for transferring heat to or from the extruder apparatus. Non-limiting examples of heat transfer media include water, glycol, alcohols, carbon dioxide, nitrogen and mixtures thereof. Noting that their state is dependent upon the operating temperature, it is understood that the materials may be a gas, liquid, solid or combinations thereof.

As used herein, the term “gasket” refers to an object that creates a seal between the screw elements, the screw shafts, the extruder apparatus or any combination of objects that must control the movement of heat transfer media and or thermal grease. A gasket is an article in any form, shape or combination thereof commonly known to those of ordinary skill in the art. Non-limiting examples of gasket materials include silicone rubber, nitrile rubber, butyl rubber, fluoropolymer, chlorosulfonated polyethylene, ethylene propylene, fluorosilicone, hydrogenated nitrile, natural rubber, perfluoroelastomer, polychloroprene, polyurethane, and styrene butadiene.

As used herein, the term “welding,” refers to any method of operably connecting the screw element onto the screw shaft as to prevent the screw element from moving with respect to the screw shaft and reduce the contact resistance between screw shaft and screw element. Non-limiting examples of welding include shielded metal arc welding, gas metal arc welding, flux-cored arc welding, and resistive welding.

As used herein, the term “liquefication” may be defined as a phase transition of a polymer material from a solid state to a softened, liquid, or near-liquid state. A “liquefication temperature” may be defined as a temperature at which the polymer material transitions from a solid state to a softened, liquid, or near-liquid state. For a semi-crystalline polymer, a “liquefication temperature” may correspond to a melting point temperature. For an amorphous polymer, a “liquefication temperature” may correspond to a glass transition temperature. Some polymers may exist as combinations or admixtures of semi-crystalline and amorphous phases, and therefore the “liquefication temperature” may refer to either a melting point temperature or a glass transition temperature depending on the material composition.

Twin-screw extrusion (hereafter, “TSE”) has been established as a prominent technique for processing homo-polymers, copolymers, and polymer blends from virgin and/or recycled sources. TSE has also been applied in the production of polymer composites and nano-composites. However, the shear mixing in TSE is often insufficiently rigorous to create a homogenous material in polymer blends. Additionally, TSE may not be effective for exfoliating (separating) or dispersing (spreading) fillers within a polymer matrix to form composites or nano-composites. Further, long TSE processing times may expose the extrusion materials to high temperature conditions that may result in thermal degradation of the initial materials. Such limitations may render TSE ineffective for producing high-performance polymer blends, composites, and nanocomposites.

Solid-state shear pulverization (hereafter, “SSSP”) and solid-state melt-extrusion (hereafter, “SSME”) techniques have been proven to achieve better dispersion of heterogeneous nucleating agents in homo-polymers compared to TSE processes. In addition, such techniques may improve the mixing of immiscible polymer blends, as well as exfoliating or dispersing fillers in polymer composites or nano-fillers in nanocomposites.

The ability to combine different polymer types into a hetero-polymeric composition may be limited by the physical-chemical properties of the individual polymers. As non-limiting examples, polymers that differ in one or more of their liquefication temperature, viscosity, and density may not readily combine in a homogeneous manner when in a liquid or softened state. It is understood that micro phase separation between polymers may occur for suspensions of liquid polymers that differ in their viscosity. Similarly, the combination of recycled polymers having added colorants may result in inhomogeneously colored products due to micro phase separation of the colorant materials. It is therefore apparent that combining polymers into hetero-polymeric compositions by liquefying the initial components may not result in favorable component mixing.

SSSP and SSME techniques may suffer from low production rates of hetero-polymeric materials because the initial materials must be processed below the liquefication temperature. During the pulverization process, the mechanical action of the pulverizing and mixing elements may lead to frictional heating of the initial polymeric material to temperatures above the liquefication temperatures of the polymers. Therefore, the production rate of SSSP and SSME techniques may be reduced to maintain the frictional heating of the polymers to temperatures below their liquefication temperature. Thus, a need exists for modifications to SSSP and SSME techniques to achieve good hetero-polymeric mixing while improving the throughput rates of these processes.

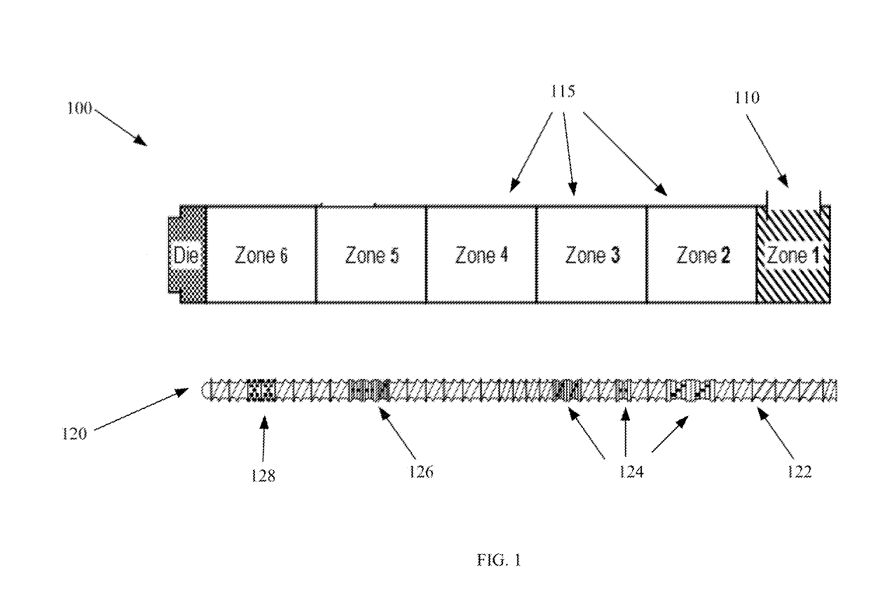

FIG. 1 depicts a non-limiting configuration of an SSSP device. In FIG. 1, an extrusion screw 120 is housed within an enclosure 100 that maintains physical contact between the polymeric materials being processed and the active elements of the extrusion screw. The extrusion screw 120 may be composed of a shaft and modular elements, or it may be a monolithic structure. The extrusion screw 120 may be composed of any material having physical characteristics capable of manipulating the polymeric materials, including, without limitation, stainless steel, aluminum, iron, high carbon steel, tempered steel, and surface-hardened metals.

Non-limiting examples of the active elements of the extrusion screw 120 may include one or more shearing elements, transport elements 122, mixing elements 124, and pulverizing elements 126, 128. The order, number, or type of the active elements along the extrusion screw 120 may not be limited to the configuration as depicted in FIG. 1, but may include any order of elements as may be required to transport, mix, combine, pulverize, or otherwise manipulate the polymeric material introduced into the SSSP. For example, additional active elements may be included to knead the polymeric material. It may be further understood that continuous operation (such as rotation) of the extrusion screw 120 may result in the polymeric material introduced at a feed chute 110 of the enclosure 100 to travel continuously along the length of the enclosure to a die end configured to dispense the final particulate mixture. In this manner, the polymer mixture may be continuously processed from introduction of the starting materials into the screw extruder to the receipt of the particulate material composed of the dispersed polymers. Along the length of the extrusion screw 120, the initial mixture of polymeric material may be subjected to mixing, grinding, and pulverizing forces generated by the mixing elements 124, pulverizing elements 126, 128, or other elements as required to achieve the required blending of materials and sizing of the final particulate material.

Although FIG. 1 illustrates a single extrusion screw 120, an SSSP device may be composed of one or more extrusion screws. In some embodiments, an SSSP device may have a plurality of extrusion screws 120 configured so that their active elements may interact to improve grinding or mixing the polymeric material. An example of such a device may be a twin extrusion screw extruder having a pair of extrusion screws proximate to each other and having their respective screw axes effectively parallel to each other.

The enclosure 100 may be divided into effective work zones, as depicted in FIG. 1 (see Zone 1-Zone 6). Such work zones may be defined in terms of the processing steps of the polymeric material and/or the temperature of the polymeric mixture therein. Thus, Zone 1 may correspond to a section in which the polymeric mixture is introduced into the extruder via the feed chute 110. One or more initial zones (for example Zone 2 and Zone 3) may correspond to sections in which the initial polymeric mixture is subjected to the action of the mixing elements 124. A buffer zone Zone 4 may be set between the mixing process and the pulverizing process occurring in one or more pulverizing zones (for example Zone 5 and Zone 6) in which the pulverizing elements 126, 128 may operate, respectively. In one embodiment, it may be understood that the one or more initial zones may incorporate all those work zones Zone 2-Zone 6 in which the polymeric mixture may be mixed, pulverized, kneaded, or otherwise physically manipulated.

Work zones Zone 1-Zone 6 may be defined functionally in terms of their operating temperatures or the mechanical processes occurring therein. Non-limiting examples of such work zones may have physical embodiments as barrel sections (for example, 115). Barrel sections 115 may be composed of segments of metal or other materials that physically surround one or more sections of the extruder screw 120 and one or more active elements such as mixing elements 124. In one non-limiting example, the enclosure 100 may be composed of one or more barrel sections 115 linked together. In another non-limiting example, the one or more barrel sections 115 may be separate structural elements contained within the enclosure 100. The one or more barrel sections 115 may be composed of any suitable material including, without limitation, stainless steel, aluminum, iron, high carbon steel, tempered steel, and surface-hardened metals.

It may be understood that the configuration of the extruder screw 120 and the active elements as disclosed in FIG. 1 is illustrative only, and is not intended to limit the possible configurations of the extruder screw or of its components. Similarly, the descriptions of the work zones or barrel sections 115 in FIG. 1 are illustrative only and are not intended to suggest a single set of temperatures, activities, number, or relative locations of such work zones.

As disclosed above, frictional heating of the composition during processing may lead to the mixture being heated to or above a liquefication temperature of at least some component of the mixture, such as a polymeric matrix material. Such frictional heating and liquefication may result in inhomogeneous mixing of the polymeric matrix material and the biologically active agent. Thus, in one embodiment, the temperature of the at least one extrusion screw 120 of the extruder may be controlled to remove at least some of the friction-induced heat from the composition. In one non-limiting embodiment, the temperature of the at least one extrusion screw 120 may be maintained at a temperature less than or equal to the liquefication temperature of the polymeric matrix material. Table I presents illustrative polymeric matrix materials and their liquefication temperatures.

TABLE I

| Polymeric | | Liquefication | Liquefication | |
|---|---|---|---|---|
| Matrix | Type of | Temperature | Temperature | |
| Material | Material | (Melting Point) | (Glass Transition) | |
| Polyethylene | Amorphous/ | 248° F.-356° F. | −130° F. | (−90° C.) |
| (high density) | Semi- | (120° C.-180° C.) | | |
| | crystalline | | | |
| Poly Ether | Amorphous/ | 662° F.-716° F. | 302° F. | (150° C.) |
| Ether Ketone | Semi- | (350° C.-380° C.) | | |
| | crystalline | | | |
| Polyurethane | Amorphous/ | 302° F.-401° F. | −18° F. | (−28° C.) |
| | Semi- | (150° C.-205° C.) | | |
| | crystalline | | | |
| Polypropylene | Amorphous/ | 266° F.-340° F. | 6.8° F. | (−14° C.) |
| | Semi- | (130° C.-171° C.) | | |
| | crystalline | | | |
| Polyethylene | Amorphous/ | 482° F.-500° F. | 158° F. | (70° C.) |
| terephthalate | Semi- | (250-260° C.) | | |
| | crystalline | | | |
| Nylon 6,6 | Amorphous/ | 491° F.-518° F. | 122° F. | (50° C.) |
| | Semi- | (255-270° C.) | | |
| | crystalline | | | |
| Polycarbonate | Amorphous | N/A | 297° F. | (147° C.) |

In some non-limiting examples, the temperature of at least one portion of the at least one extrusion screw 120 may be maintained at a temperature of about 35° F. to about 45° F. (about 1.7° C. to about 7.2° C.). Some non-limiting examples of temperatures at which the at least one portion of the at least one extrusion screw 120 may be maintained may include a temperature of about 35° F. (about 1.7° C.), about 37° F. (about 2.8° C.), about 39° F. (about 3.9° C.), about 40° F. (about 4.4° C.), about 42° F. (about 5.6° C.), about 44° F. (about 6.7° C.), about 45° F. (about 7.2° C.), or ranges between any two of these values including endpoints. As one example, the one or more extrusion screw 120 may be maintained at a temperature of about 40° F. (about 4.4° C.). Because the polymeric matrix materials may not have high thermal conductivity, the extrusion screw 120 may be maintained at temperatures significantly lower than the liquefication temperature of the biocompatible matrix material in order to maintain the matrix material in a solid state. For example, it may be necessary to maintain the extrusion screw 120 temperature at about 12° F. (about −11° C.) in order to maintain the temperature of the polymeric materials at about 38° F. (about 3.3° C.) during the manipulation steps of the extruder.

It may be understood that the material in any of the one or more work zones or barrel sections 115 in an SSSP device as illustrated in FIG. 1 may be maintained at a temperature equal to or less than a liquefication temperature of any of the components, for example one or more of the polymeric materials. Such work zones or barrel sections 115 may include, without limitation, a work zone in which the polymeric materials are introduced into the extruder (for example, Zone 1), one or more initial zones (for example, Zone 2 and Zone 3), a buffer zone (for example Zone 4), one or more pulverizing zones (for example, Zone 5 and Zone 6), and a delivery zone (for example, Die).

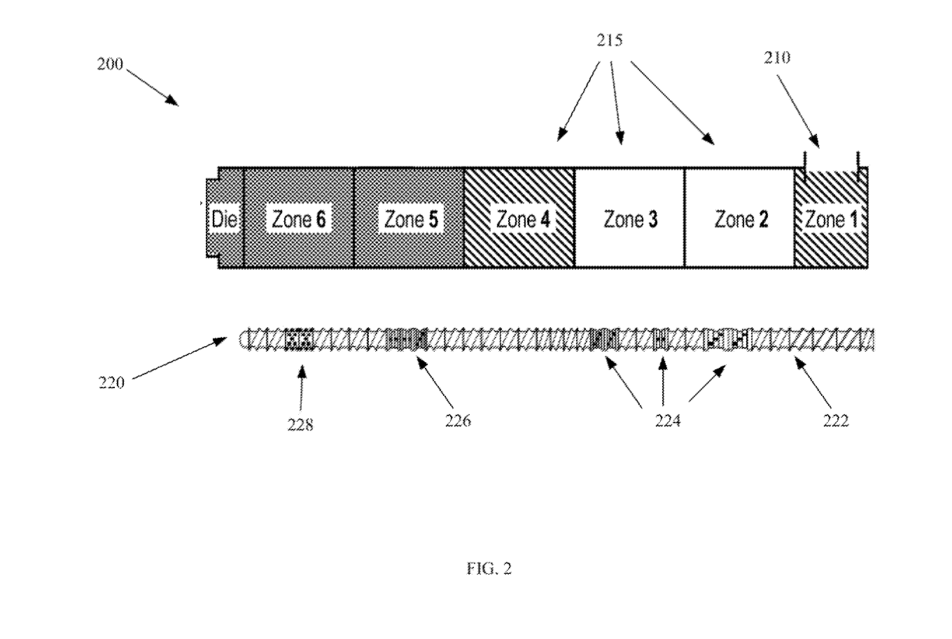

FIG. 2 depicts a non-limiting configuration of an SSME device. In FIG. 2, an extrusion screw 220 is housed within an enclosure 200 that maintains physical contact between the mixture of polymeric material being processed and the active elements of the extrusion screw. The extrusion screw 220 may be composed of a shaft and modular elements, or may be a monolithic structure. The extrusion screw 220 may be composed of any material having physical characteristics capable of manipulating the polymeric materials, including, without limitation, stainless steel, aluminum, iron, high carbon steel, tempered steel, and surface-hardened metals.

Non-limiting examples of the active elements of the extrusion screw 220 may include one or more shearing elements, transport elements 222, pulverizing elements 224, kneading elements 226, and mixing elements 228. The order, number, or type of the active elements along the extrusion screw 220 may not be limited to the configuration as depicted in FIG. 2, but may include any order of elements as may be required to transport, mix, combine, pulverize, or otherwise manipulate the polymeric material introduced into the SSME. It may be further understood that continuous operation (such as rotation) of the extrusion screw 220 may result in the polymeric material introduced at a feed chute 210 of the enclosure 200 to travel continuously along the length of the enclosure to a die end configured to extrude the final fluid mixture. In this manner, the polymer mixture may be continuously processed from introduction of the starting materials into the screw extruder to the receipt of the extruded fluid material composed of the dispersed polymers. Along the length of the extrusion screw 220, the initial mixture of polymeric material may be subjected to mixing, grinding, and pulverizing forces generated by the pulverizing elements 224, kneading elements 226, mixing elements 228, or other elements as required to achieve the required blending of materials.

Although FIG. 2 illustrates a single extrusion screw 220, an SSME device may be composed of one or more extrusion screws. In some embodiments, an SSME device may have a plurality of extrusion screws 220 configured so that their active elements may interact to improve grinding or mixing the polymeric material. An example of such a device may be a twin extrusion screw extruder having a pair of extrusion screws proximate to each other and having their respective screw axes effectively parallel to each other.

The enclosure 200 in which the one or more extrusion screws 220 are housed may be divided into effective work zones, as depicted in FIG. 2 (see Zone 1-Zone 6). Such work zones may be defined in terms of their respective temperatures and/or the processing steps of the polymeric material within them. Thus, Zone 1 may correspond to a section in which the polymeric mixture is introduced into the extruder via the feed chute 210 at an ambient temperature. One or more initial zones (for example, Zone 2 and Zone 3) may correspond to sections in which the initial polymeric mixture may be subjected to the action of the pulverizing elements 224 thereby producing a sheared mixture of the polymer material. During the pulverization process, the polymeric material may be kept at a temperature at or below the liquefication temperature of the polymeric mixture. Thus, the one or more initial zones (Zone 2 and Zone 3) may include temperature control elements (for example, as part of the one or more extrusion screws 220) to maintain the temperature of the polymeric material in those work zones at or below the liquefication temperature of the polymeric mixture. Transition zone Zone 4 may be a buffer zone between the pulverizing process in the one or more initial zones (Zone 2 and Zone 3), and the kneading process occurring in one or more heating zones (for example Zone 5).

While the SSSP process produces particulate material, the SSME process incorporates an additional melt extrusion step. Consequently, the SSME extruder depicted in FIG. 2 includes additional processing steps to melt the particulate polymeric mixture to produce an extruded composition such as a wire, a sheet, a tube, a multi-lumen tube, or any other profile extruded from a die commonly known to those having ordinary skill in the art. The melting process may occur for example in one or more heating zones (for example, in Zone 5 and Zone 6) in which the kneading elements 226 and mixing elements 228 may operate, respectively. The temperature in the zones manipulating the melted sheared mixture may be greater than or equal to a liquefication temperature of the polymeric mixture. Because the sheared material produced in the one or more initial zones (Zone 2 and Zone 3) may be at a temperature at or below the liquefication temperature of the polymeric mixture, and the melted material in the one or more heating zones (Zone 5 and Zone 6) may be at a temperature at or above the liquefication temperature of the polymeric mixture, the sheared mixture transported from Zone 3 to Zone 5 may be at an intermediate temperature as it is transported through the transition zone Zone 4. As a non-limiting example, the polymeric mixture in the one or more initial zones (Zone 2 and Zone 3) may be maintained at a temperature of about 38° F. (about 3.3° C.), the melted sheared mixture in the one or more heating zones (Zone 5 and Zone 6) may be maintained at a temperature of about 400° F. (about 204° C.), and the transported sheared material may have an average temperature of about 70° F. (about 21° C.) as it transits through transition zone Zone 4. It may be appreciated that the sheared mixture may be warmed from a temperature at or below a liquefication temperature to a temperature at or above the liquefication temperature of the polymer as it is transferred through the transition zone.

Work zones Zone 1-Zone 6 may be defined functionally in terms of their operating temperatures or the mechanical processes occurring therein. Non-limiting examples of such work zones may have physical embodiments such as barrel sections (for example, 215). Barrel sections 215 may be composed of segments of metal or other materials that may physically surround one or more sections of the extruder screw 220 and one or more active elements such as pulverizing elements 224. In one non-limiting example, the enclosure 200 may be composed of one or more barrel sections 215 linked together. In another non-limiting example, the one or more barrel sections 215 may be separate structural elements contained within the enclosure 200. The one or more barrel sections 215 may be composed of any suitable material including, without limitation, stainless steel, aluminum, iron, high carbon steel, tempered steel, and surface-hardened metals.

It may be understood that the configuration of the extruder screw 220 and the active elements as disclosed in FIG. 2 is illustrative only and is not intended to limit the possible configurations of the extruder screw or of its components. Similarly, the descriptions of the work zones and barrel sections 215 in FIG. 2 are illustrative only and are not intended to suggest a single set of temperatures, activities, or number of such work zones.

As disclosed above, frictional heating of the polymeric mixture during processing may lead to the mixture being heated to or above a liquefication temperature of at least some component of the mixture. Such frictional heating and liquefication may result in inhomogeneous mixing of the polymeric material during pulverization. In one non-limiting embodiment, the temperature of one or more portions of the at least one extrusion screw 220 having active elements that may pulverize the polymer mixture (for example, in one or more initial zones such as Zone 2 and Zone 3) may be maintained at a temperature less than or equal to the liquefication temperature of the polymeric mixture. In some non-limiting examples, the temperature of the one or more portions of the at least one extrusion screw 220 having active elements to pulverize the polymer mixture may be maintained at a temperature of about 35° F. to about 45° F. (about 1.7° C. to about 7.2° C.). Some non-limiting examples of temperatures at which at least one portion of the at least one extrusion screw 220 may be maintained may include a temperature of about 35° F. (about 1.7° C.), about 37° F. (about 2.8° C.), about 39° F. (about 3.9° C.), about 40° F. (about 4.4° C.), about 42° F. (about 5.6° C.), about 44° F. (about 6.7° C.), about 45° F. (about 7.2° C.), or ranges between any two of these values including endpoints.

Similarly, the temperature of one or more portions of the at least one extrusion screw 220 having active elements to mix or knead the melted sheared polymer mixture (for example, in one or more heating zones such as Zone 5 and Zone 6) may be maintained at a temperature greater than or equal to the liquefication temperature of the polymeric mixture. In some non-limiting examples, the temperature of one or more portions of the at least one extrusion screw 220 having active elements to mix or knead the melted polymer mixture may be maintained at a temperature of about 90° F. to about 500° F. (about 32° C. to about 260° C.). Some non-limiting examples of temperatures at which the at least one extrusion screw 220 may be maintained to mix or knead the melted polymer mixture may include a temperature of about 90° F. (about 32° C.), about 199° F. (about 93° C.), about 250° F. (about 121° C.), about 300° F. (about 149° C.), about 351° F. (about 177° C.), about 399° F. (about 204° C.), about 450° F. (about 232° C.), about 500° F. (about 260° C.), or ranges between any two of these values including endpoints.

It may be understood that temperature control, such as cooling, of the polymeric matrix materials and filler materials, either separately or in any combination throughout the manipulations by the screw extrusion device may be accomplished by any appropriate means.

Cooling may be accomplished by cooling one or more portions of the extrusion screw according to the type of manipulation of the material contacting the extrusion screw (for example, in one or more initial zones such as Zone 2 and Zone 3 in FIG. 2). A portion of the enclosure 100 (FIG. 1) or 200 (FIG. 2) encompassing the extrusion screw or barrel sections 115 (FIG. 1) or 215 (FIG. 2) may also be cooled according to the type of manipulation of the material therein (for example, in Zone 2, Zone 3, Zone 4, and Zone 5 in FIG. 1). Such cooling may be accomplished through the use of one or more of a heat exchange coil, a compressor, a refrigerator, and a solid state cooling device through a temperature control system. In one non-limiting example, heat exchange tubing may be placed in thermal contact with one or more of portions of the one or more extrusion screws 120, 220, one or more active elements 124, 126, 128, 224, 226, and 228, one or more barrel sections 115, 215, and one or more sections of the enclosure 100, 200. The heat exchange tubing may be filled with a recirculating refrigeration liquid, such as a mixture of water and ethylene glycol. The refrigeration liquid may be kept at a constant temperature according to devices and control systems as are known in the art.

It may be understood that the one or more portions of the enclosure 100, 200, extrusion screw 120, 220, barrel sections 115, 215, and active elements 124, 126, 128, 224, 226, and 228, may be controlled to have any appropriate temperature such as a temperature at or below a liquefication temperature of one or more components of the polymer matrix materials. It may further be understood that each of the one or more portions of the enclosure 100, 200, extrusion screw 120, 220, barrel sections 115, 215, and active elements 124, 126, 128, 224, 226, and 228, may be controlled to have about the same temperature or a different temperature. In some non-limiting examples, the one or more portions of the enclosure 100, 200, extrusion screw 120, 220, barrel sections 115, 215, and active elements 124, 126, 128, 224, 226, and 228, may be controlled to have a temperature less than or equal to about 40° C. In some other non-limiting examples, the one or more portions of the enclosure 100, 200, extrusion screw 120, 220, barrel sections 115, 215, and active elements 124, 126, 128, 224, 226, and 228, may be controlled to have a temperature of about 35° C. to about 45° C.

With respect to SSME processing, heating of the particulate form of the biologically active agent delivery composition may be accomplished by heating one or more portions of the extrusion screw according to the type of manipulation of the polymeric material contacting the extrusion screw (for example, in one or more heating zones such as Zone 5 and Zone 6 in FIG. 2). A portion of the physical enclosure 200 of the extrusion screw or barrel section 215 may also be heated according to the type of manipulation of the polymeric material therein (for example, one or more heating zones such as Zone 5 and Zone 6 in FIG. 2). Such heating may be accomplished through the use of one or more of a resistive heating element, a heat transfer coil, and a radiant heating device. Because some portions of an SSME processing device may be kept at a temperature at or above a liquefication temperature of the biocompatible polymer material, while other portions may be kept at a temperature at or below a liquefication temperature, thermal insulating components or devices may be required to provide thermal barriers between the high temperature and low temperature portions of the physical enclosure 200 or between barrel sections 215.

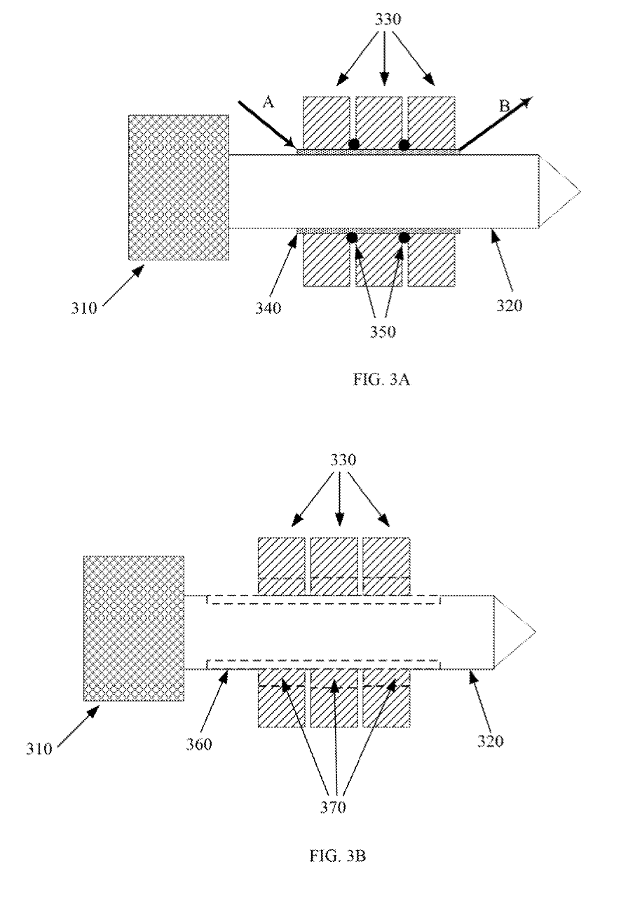

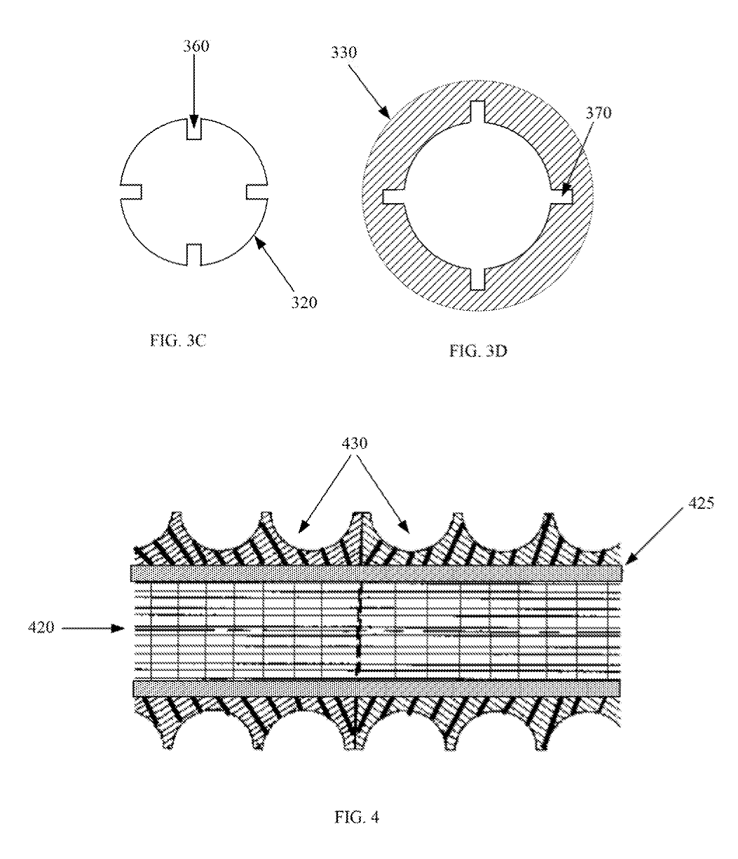

FIG. 3A depicts one embodiment of an extrusion screw assembly that may be used in a solid-state extruder. The extrusion screw assembly may include a rotary drive unit 310 configured to rotate an extrusion screw shaft 320. The extrusion screw shaft 320 may be placed in mechanical communication with one or more extrusion screw elements 330. The mechanical communication may allow a rotary force imparted to the extrusion screw shaft 320 by the rotary drive unit 310 to impart a rotational motion to the one or more extrusion screw elements 330. As disclosed above, with respect to FIGS. 1 and 2, the extrusion screw elements 330 may comprise one or more elements configured to mix, grind, pulverize, knead, shear, or transport materials introduced into the solid-state extruder. The rotary drive unit 310 may be configured to rotate the extrusion screw shaft 320 in a clockwise direction, a counterclockwise direction, or alternate rotation between a clockwise direction and a counterclockwise direction.

It may be understood that the mechanical communication between the extrusion screw shaft 320 and the one or more extrusion screw elements 330 may include direct physical contact between an outer surface of the extrusion screw shaft and an inner surface of the one or more extrusion screw elements. Alternatively, some amount of space may be left between outer surface of the extrusion screw shaft 320 and an inner surface of the one or more extrusion screw elements 330. In some embodiments, an amount of a heat conducting medium 340 may be placed within a space between the outer surface of the extrusion screw shaft 320 and an inner surface of the one or more extrusion screw elements 330.

In some embodiments, the heat conducting medium 340 may include a viscous non-flowing material such as a thermal grease. Non-limiting examples of a thermal grease may include non-electrically conductive, silicone and zinc thermal greases, and electrically conductive, silver, copper, and aluminum-based greases. In other embodiments, the heat conducting medium 340 may include less viscous material capable of flowing within a space between an outer surface of the extrusion screw shaft 320 and an inner surface of the one or more extrusion screw elements 330. Non-limiting examples of such less viscous heat transfer media may include water, glycol, alcohols, carbon dioxide, nitrogen and mixtures thereof. Noting that its state may be dependent upon an operating temperature, a heat transfer medium may be a gas, a liquid, a solid, or any combination thereof.

In one non-limiting example, as depicted in FIG. 3A, the heat conducting medium 340 may flow in a direction from A to B along an outer surface of the extrusion screw shaft 320, thereby conducting heat generated by the actions of the one or more extrusion screw elements 330 along the outer surface of the extrusion screw shaft and away from the one or more extrusion screw elements. In some non-limiting examples, the heat conducting medium 340 may flow from a source of the heat conducting medium at A and may flow to a sink of the heat conducting medium at B. In another non-limiting example, the heat conducting medium 340 may circulate from a source having a temperature controlled by a temperature controller. In such an example, heat absorbed by the heat conducting medium 340 from the one or more extrusion screw elements 330 may be removed at the source of the heat conducting medium by the temperature controller while the heat conducting medium circulates.

In yet another embodiment, gaskets 350 may be placed around the extrusion screw shaft 320 to form fluid seals between adjoining extrusion screw elements 330. Non-limiting examples of gasket materials may include one or more of a silicone rubber, a nitrile rubber, a butyl rubber, a fluoropolymer, a chlorosulfonated polyethylene, an ethylene propylene, a fluorosilicone, a hydrogenated nitrile, a natural rubber, a perfluoroelastomer, a polychloroprene, a polyurethane, and a styrene butadiene. The gaskets 350 may be placed with respect to the extrusion screw elements 330 to allow the heat conducting medium 340 to flow along a length of the extrusion screw shaft 320. In one non-limiting example, the gaskets 350 may be placed between facing surfaces of successive extrusion screw elements 330. In this manner, the heat conducting medium 340 may flow along a length of the extrusion screw shaft 320 and absorb heat from a number of extrusion screw elements 330 without leaking between the elements.

FIGS. 3B-3D depict additional embodiments of an extrusion screw assembly. FIG. 3B depicts a non-limiting example of a longitudinal view of the assembly and FIGS. 3C and 3D depict non-limiting examples of cross-sectional views of components of the extrusion screw assembly. FIG. 3B depicts a non-limiting embodiment of an extrusion screw assembly including a rotary drive unit 310 configured to rotate an extrusion screw shaft 320. The extrusion screw shaft 320 may be placed in mechanical communication with one or more extrusion screw elements 330. As depicted in FIG. 3B, the extrusion screw shaft 320 may include one or more extrusion shaft channels 360. In some embodiments, the heat conducting medium 340 may be a low viscosity material that can be induced to flow within the one or more extrusion shaft channels 360.

In one embodiment, the extrusion screw shaft 320 may include one or more extrusion shaft channels 360 fabricated on an exterior surface of the extrusion screw shaft. In one non-limiting example, the one or more extrusion shaft channels 360 may be linear channels, fabricated on an exterior surface of the extrusion screw shaft, which extend effectively parallel to a longitudinal axis of the extrusion screw shaft 320. In another non-limiting example, the one or more extrusion shaft channels 360 may be helical channels fabricated on an exterior surface of the extrusion screw shaft, each helical channel having a helical axis that runs effectively parallel to the longitudinal axis of the extrusion screw shaft 320. It may be understood that the number of such extrusion shaft channels 360 on the extrusion screw shaft 320 is not limited. It may also be understood that the orientations of such extrusion shaft channels 360 with respect to either each other or with respect to any geometric parameter that may characterize the extrusion screw shaft 320 are also not limited.

FIG. 3C depicts a cross-section of an extrusion screw shaft 320 illustrating one or more extrusion shaft channels 360 that are fabricated on an exterior surface of the screw shaft. It may be recognized that the cross-sectional geometry of the extrusion shaft channels 360 is arbitrary and may include, as non-limiting examples, a square cross-section, a rectangular cross-section, a triangular cross-section, or a rounded cross-section.

Additionally, as depicted in FIG. 3B, each of the one or more extrusion screw elements 330 may include one or more extrusion element channels 370. In some embodiments, the heat conducting medium 340 may be a low viscosity material that can be induced to flow within the one or more extrusion element channels 370.

In one embodiment, each of the one or more extrusion screw elements 330 may include one or more extrusion element channels 370 fabricated on an interior surface of each of the one or more extrusion screw elements. In one non-limiting example, the one or more extrusion element channels 370 may be linear channels, fabricated on an interior surface of an extrusion screw element, which extend effectively parallel to a longitudinal axis of the extrusion screw shaft 320 on which the extrusion screw element may be mounted. In another non-limiting example, the one or more extrusion element channels 370 may be helical channels, fabricated on an interior surface of an extrusion screw element, each helical channel having a helical axis that runs effectively parallel to the longitudinal axis of the extrusion screw shaft 320. It may be understood that the number of such extrusion element channels 370 on any one or more extrusion screw elements 330 is not limited. It may also be understood that the orientations of such extrusion element channels 370 with respect to either each other or with respect to any geometric parameter that may characterize the extrusion screw shaft 320 are also not limited.

FIG. 3D depicts a non-limiting example of a cross-section of an extrusion screw element 330 illustrating one or more extrusion element channels 370 that may be fabricated on an interior surface of the extrusion screw element. It may be recognized that the cross-sectional geometry of the extrusion element channels 370 is arbitrary and may include, as non-limiting examples, a square cross-section, a rectangular cross-section, a triangular cross-section, or a rounded cross-section.

It may be understood that an extrusion screw assembly may include one or more extrusion shaft channels 360, one or more extrusion element channels 370, or any combination thereof. In one non-limiting example, an extrusion screw assembly may include one or more extrusion shaft channels 360 and one or more extrusion element channels 370, in which the one or more extrusion shaft channels may be aligned with the one or more extrusion element channels to provide paths for a heat conducting medium 340 to flow through both sets of channels.

Heat transfer media may be caused to flow through an extrusion shaft channel 360 and/or one or more extrusion element channels 370 according to any method as known to those skilled in the art. In one non-limiting embodiment, a rotary union may be used as depicted in FIG. 3E. A rotary union 380 may include a non-rotating body which may be in physical communication with all or part of a rotatable extrusion screw shaft 320. The rotary union 380 may include one or more rotary seals 370 that may be placed along at least a portion of a length of the extrusion screw shaft 320. The rotary union 380 may further include one or more access ports 385 which may serve as inlets or outlets to one or more reservoirs 390 within the rotary union. In one non-limiting example, an amount of a heat transfer medium may be introduced by means of an access port 385 into a reservoir 390 within a rotary union 380. A rotatable extrusion screw shaft 320 may be placed through or within the rotary union 380 and a surface of the screw shaft may contact the heat transfer medium within the reservoir 390. Rotary seals 370 may be placed within the rotary union 380 and against the exterior surface of the rotatable extrusion screw shaft 320. As depicted in FIG. 3E, the rotary seals 370 may be disposed so that the heat transfer medium within the reservoir 390 may not travel out of the reservoir and along the exterior surface of the rotatable shaft. The rotary seals 370, however, may be disposed to permit the transfer medium from the reservoir 390 to fill the one or more extrusion shaft channels 360 along a length of the rotatable extrusion screw shaft 320.

It may be understood that a rotary union 380 may be used to receive heat transfer media that may flow along one or more extrusion shaft channels 360. In such a case, heat transfer media that may flow along one or more extrusion shaft channels 360 may be received in a reservoir 390 within a rotary union 380 and may exit the reservoir by means of one or more access ports 385.

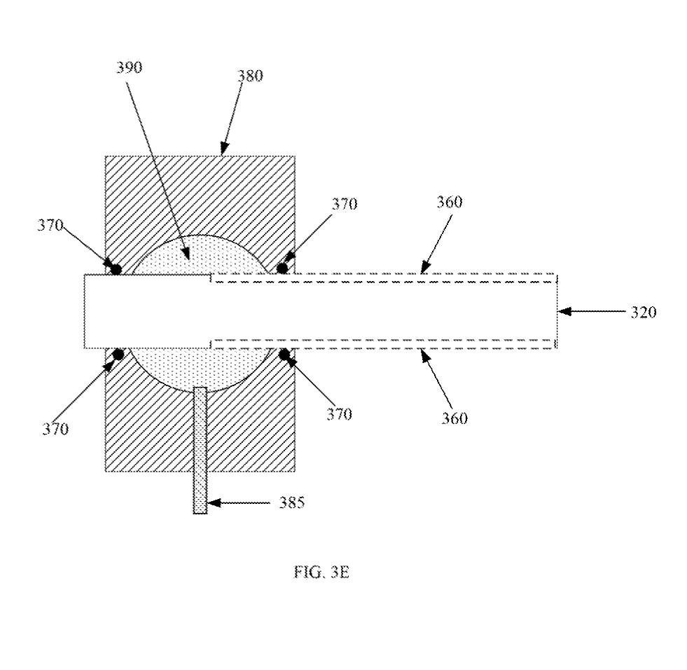

FIG. 4 depicts another embodiment of an extrusion screw assembly comprising an extrusion screw shaft 420 in mechanical communication with a plurality of extrusion screw elements 430. Disposed between the extrusion screw shaft 420 and the plurality of extrusion screw elements 430 may be a layer of a thermal grease 425. As disclosed above, the thermal grease 425 may be a high viscosity material with acceptable thermal conduction properties that does not normally flow during use. Such a thermal grease 425 may be applied to the extrusion screw shaft 420 before the one or more extrusion screw elements 430 are placed on the extrusion screw shaft.

In some non-limiting examples, the extrusion screw shaft 420 may have a non-circular cross-section, for example a square cross-section or a splined cross-section. The one or more extrusion screw elements 430 may have an interior surface having a cross-section configured to match the geometry of the exterior of the extrusion screw shaft 420. An extrusion screw shaft 420 having a non-circular cross-section may be able to drive one or more extrusion screw elements 430 having a mating non-circular cross-section interior cut-out portion due to mechanical interactions therebetween. Such mechanical interactions may not be adversely affected by an intervening layer of a thermal grease 425.

FIG. 5 depicts another embodiment of an extrusion screw assembly comprising an extrusion screw shaft 520 in mechanical communication with a plurality of extrusion screw elements 530. Each of the plurality of extrusion screw elements 530 may be mechanically connected to the extrusion screw shaft 520 by means of one or more welds 525. The welds may permit direct heat transfer from the one or more extrusion screw elements 530 to the extrusion screw shaft 520.

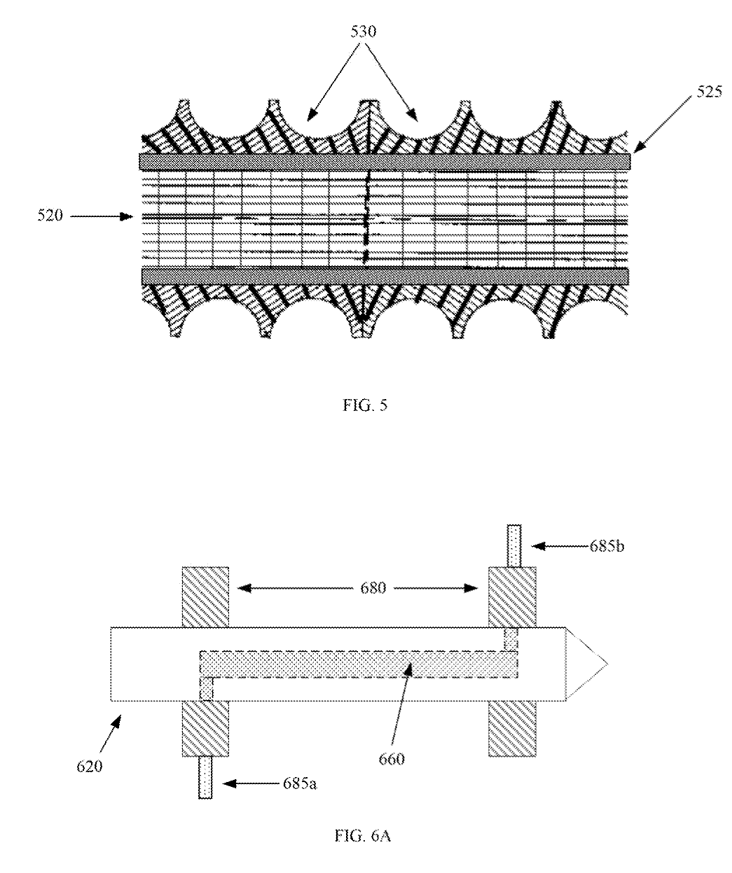

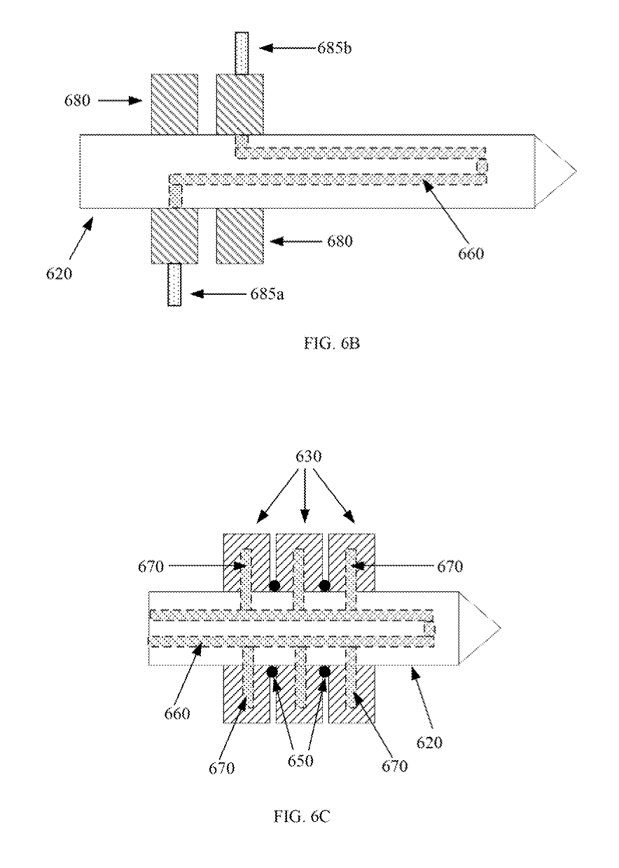

FIGS. 6A-6C illustrate a plurality of embodiments of an extrusion screw assembly each depicting one or more extrusion shaft channels 660 fabricated within an interior of an extrusion screw shaft 620. Although FIGS. 6A and 6B do not depict one or more extrusion screw elements, it may be understood that such elements may also be placed in mechanical communication with the extrusion screw shaft 620 in manners analogous to those depicted in one or more of FIG. 3A, FIG. 3B, FIG. 4, and FIG. 5.

FIG. 6A depicts an extrusion screw assembly illustrating an extrusion shaft channel 660 fabricated within the body of an extrusion screw shaft 620. Such an extrusion shaft channel 660 may be fabricated using any method known in the art including, without limitation, milling, drilling, molding, and extrusion. The extrusion shaft channel 660 may extend along the entire length of the extrusion screw shaft 620 or may extend along only a portion of the length of the extrusion screw shaft. There may be a single extrusion shaft channel 660 or a plurality of such channels. A plurality of extrusion shaft channels 660 may be disposed parallel to each other, sequentially along the length of the extrusion screw shaft 620, or a combination of both parallel and sequentially (for example, two such channels may be parallel to each other, but their end points may be linearly offset from each other). Some portion of an extrusion shaft channel 660 may extend to an exterior surface of the extrusion screw shaft 620, thereby providing access to the channel for a flow of a heat transfer medium. In some non-limiting examples, an extrusion shaft channel 660 may extend to an exterior surface of the extrusion screw shaft 620 at one or more ends of the extrusion screw shaft. In some other non-limiting examples, as depicted in FIG. 6A, an extrusion shaft channel 660 may extend at one or more areas to an exterior side surface of the extrusion screw shaft 620.

A heat transfer medium may be introduced into an extrusion shaft channel 660 from a source of the heat transfer medium external to the extrusion screw shaft 620. The heat transfer medium may be introduced into an extrusion shaft channel 660 using one or more rotary unions 680. Such rotary unions 680 permit the extrusion screw shaft 620 to rotate within the one or more rotary unions while the rotary unions remain stationary with respect to the source of the heat transfer medium. Each rotary union 680 may include an access port 685a,b. An access port (for example 685a) may serve as an inlet for the heat transfer medium, permitting the heat transfer medium to enter an extrusion shaft channel 660 through one or more extensions of the channel to the surface of the extrusion screw shaft 620. Alternatively, an access port (for example 685b) may serve as an outlet for the heat transfer medium, permitting the heat transfer medium to exit an extrusion shaft channel 660 through one or more extensions of the channel to the surface of the extrusion screw shaft 620.

In one non-limiting example, a heat transfer medium circulating system may transfer the heat transfer medium from its source, through an access port 685a in a rotary union 680, and into an extrusion shaft channel 660. The circulating system may then receive the heat transfer medium from the extrusion shaft channel 660 via a second access port 685b in a rotary union 680. In one non-limiting application, the heat transfer medium circulating system may transfer a cold medium through the extrusion shaft channel 660 where the medium may absorb heat from the extrusion screw shaft 620 due to the mechanical actions of the extrusion screw elements on a polymer mixture. The heated medium may be transferred by the circulating system to a heat transfer medium source in which the heated medium is cooled to an appropriate temperature. In another non-limiting application, the heat transfer medium circulating system may transfer a heated medium through the extrusion shaft channel 660 to heat the extrusion screw shaft 620 and the extrusion screw elements (as well as polymer mixture). The heat transfer medium may then be recovered from the extrusion shaft channel 660 and reheated in the heat transfer medium source.

FIG. 6B depicts an alternative example of an extrusion screw assembly illustrating an extrusion shaft channel 660 fabricated within the body of an extrusion screw shaft 620. In the example depicted in FIG. 6B, the extrusion shaft channel 660 extends along an interior length of the extrusion screw shaft 620 and then extends in a reverse direction within the interior length of the extrusion screw shaft. The extrusion screw assembly also comprises one or more rotary unions 680, each union including one or more access ports 685a,b. FIG. 6B illustrates a non-limiting embodiment comprising two rotary unions 680, a first union configured with an access port 685a to allow a heat transfer medium to enter the extrusion shaft channel 660, and a second union configured with an access port 685b to allow a heat transfer medium to exit the extrusion shaft channel.

In an alternative embodiment, a single rotary union 680 may include a first access port 685a to allow a heat transfer medium to enter the extrusion shaft channel 660, and a second access port 685b to allow a heat transfer medium to exit the extrusion shaft channel. The two access ports 685a,b may be oriented so that a first end of the extrusion shaft channel 660 can align only with a first access port (for example 685a) while a second end of the extrusion shaft channel can align only with a second access port (for example 685b). In this manner a unidirectional flow of the heat transfer medium may be maintained through the extrusion shaft channel 660.

FIG. 6C depicts yet another example of an extrusion screw assembly illustrating an extrusion shaft channel 660 fabricated within the body of an extrusion screw shaft 620. The extrusion screw assembly depicted in FIG. 6C also depicts a plurality of extrusion screw elements 630. Each of one or more of the extrusion screw elements 630 may include one or more extrusion element channels 670. In the example depicted in FIG. 6C, the extrusion shaft channel 660 may extend along an interior length of the extrusion screw shaft 620 and then extend in a reverse direction within the interior length of the extrusion screw shaft. One or more portions of an extrusion shaft channel 660 may extend to an exterior surface of the extrusion screw shaft 620. The extended portions of the extrusion shaft channel 660 may align with the extrusion element channels 670, thereby allowing an exchange of the heat transfer medium between the extrusion shaft channel 660 and the one or more extrusion element channels 670. In the non-limiting embodiment depicted in FIG. 6C, heat generated by the one or more extrusion screw elements 630 may be transferred more efficiently into the heat transfer medium compared to the embodiments depicted in FIG. 6A or 6B.

As disclosed above with respect to FIG. 4, the extrusion screw elements 630 may be placed in physical communication with an extrusion screw shaft 620 in a removable manner (for example, by sliding the elements onto the shaft without further fixing the elements to the shaft). With respect to FIG. 5, the extrusion screw elements 630 may be placed in physical communication with an extrusion screw shaft 620 in a fixed manner (for example, by sliding the elements onto the shaft and then welding them in place on the shaft).

A method of placing the extrusion screw elements 630 in physical communication with an extrusion screw shaft 620, as depicted in FIG. 6C, may also include a fixed placement method or a removable placement method. In a fixed placement method, the extrusion screw elements 630 may be slid onto the extrusion screw shaft 620 and then welded in place on the shaft in a manner to align the extrusion element channels 670 with the extensions of the extrusion shaft channel 660. The resulting welds may be sufficiently tight to prevent the heat transfer medium from leaking out of one or more of the extrusion element channels 670 and the extrusion shaft channel 660.

In a removable placement method, the extrusion screw elements 630 may be slid onto the extrusion screw shaft 620 without otherwise fixing them onto the shaft. Because the extrusion screw elements 630 may not be welded onto the extrusion screw shaft 620, gaskets 650 may be placed between surfaces of adjacent extrusion screw elements to prevent loss of the heat transfer medium. Such gaskets 650 may contact only the surfaces of adjacent extrusion screw elements 630 or they may also contact one or more exterior surfaces of the extrusion screw shaft 620.

It may be understood, in light of the disclosure regarding FIGS. 1 and 2, that embodiments of an extrusion screw assembly as depicted in FIGS. 3-6 and the disclosures thereof are not limited in terms of the number, types, placements, or orientation of extrusion screw elements with respect to an extrusion screw shaft. Additionally, the number and orientations of extrusion screw shafts associated with an extrusion screw assembly are similarly not limited. Further, an extrusion screw assembly may include any one or more components and methods disclosed above capable of providing temperature control to the one or more extrusion screw shafts and extrusion screw elements associated therewith.

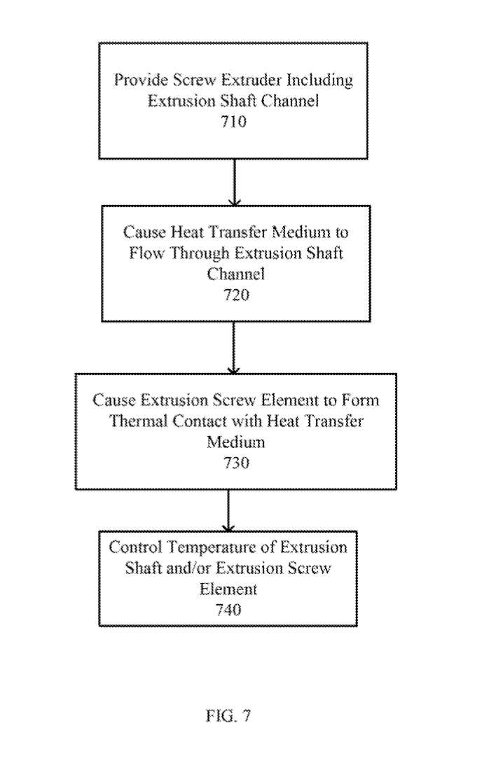

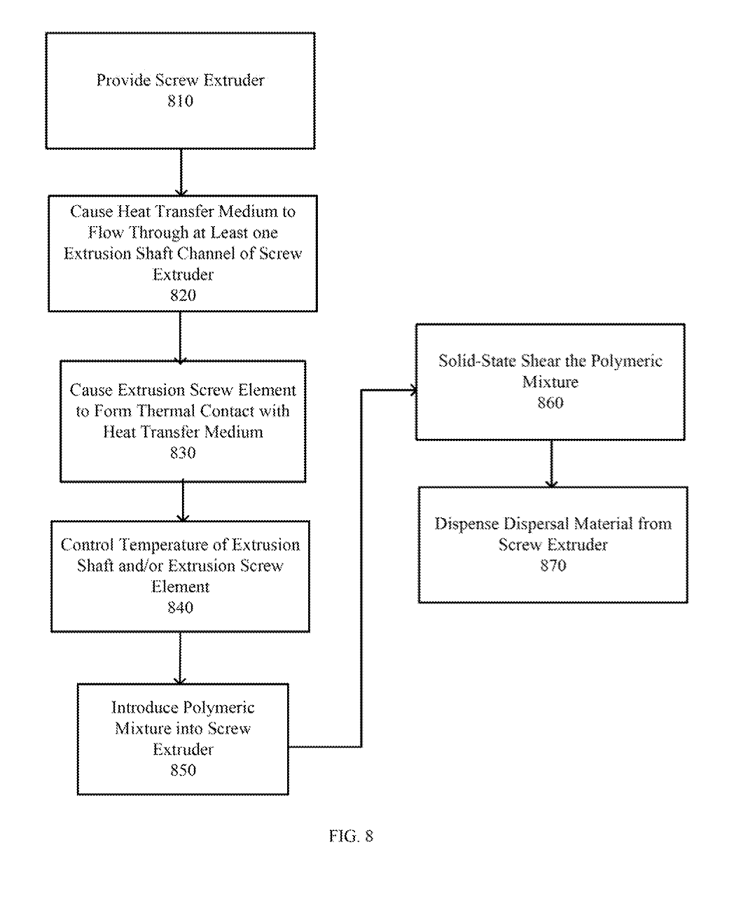

FIG. 7 is a flow chart of an exemplary method for controlling a temperature in a screw extruder. A screw extruder incorporating an extrusion screw assembly may be provided 710. The extrusion screw assembly may include at least one extrusion screw shaft having at least one extrusion shaft channel along at least a portion of its length and at least one extrusion screw element in mechanical communication with the at least one extrusion screw shaft. The at least one extrusion shaft channel may be configured to transfer a heat transfer medium along at least a portion of its length. The screw extruder may also include a source of a heat transfer medium, a temperature controller configured to control a temperature of the heat transfer medium, an enclosure surrounding the extrusion screw assembly, and a feed chute configured to introduce one or more polymeric materials into the screw extruder.

The source of a heat transfer material may also include a pump or other mechanism configured to cause 720 the heat transfer medium to flow from the source of the heat transfer medium through the at least one extrusion shaft channel. The at least one extrusion screw element may be placed in thermal communication with the extrusion screw shaft causing 730 the at least one extrusion screw element to form a thermal contact with the heat transfer medium flowing through the at least one extrusion shaft channel. A temperature of one or more of the at least one extrusion screw shaft and the at least one extrusion screw element may be controlled 740 by the temperature controller via the heat transfer medium flowing from the source of the heat transfer medium.

FIG. 8 is a flow chart of an exemplary method of dispersing materials in a polymeric composition. A screw extruder incorporating an extrusion screw assembly may be provided 810. The extrusion screw assembly may include at least one extrusion screw shaft having at least one extrusion shaft channel along at least a portion of its length and at least one extrusion screw element in mechanical communication with the at least one extrusion screw shaft. The at least one extrusion shaft channel may be configured to transfer a heat transfer medium along at least a portion of its length. The screw extruder may also include a source of a heat transfer medium, a temperature controller configured to control a temperature of the heat transfer medium, an enclosure surrounding the extrusion screw assembly, and a feed chute configured to introduce one or more polymeric materials into the screw extruder.

The source of a heat transfer material may also include a pump or other mechanism configured to cause 820 the heat transfer medium to flow from the source of the heat transfer medium through the at least one extrusion shaft channel. The at least one extrusion screw element may be placed in thermal communication with the extrusion screw shaft causing 830 the at least one extrusion screw element to form a thermal contact with the heat transfer medium flowing through the at least one extrusion shaft channel. A temperature of one or more of the at least one extrusion screw shaft and the at least one extrusion screw element may be controlled 840 by the temperature controller via the heat transfer medium flowing from the source of the heat transfer medium.

One or more polymer matrix materials may be introduced 850 into the screw extruder, for example through an extruder feed chute. A sheared mixture starting material may be produced in at least an initial zone of the extruder by means of solid-state shearing 860 of the polymer matrix materials. Such a sheared mixture may be fabricated by any combination of mixing, pulverizing, or kneading the polymer matrix materials by one or more active elements of the extruder. The sheared mixture may be dispensed 870 from the extruder at a dispensing end as a particulate composition. In one non-limiting example, a dispensed composition may be fabricated as a fine particulate material having an average particle diameter of about 1 μm to about 10 μm. Some non-limiting examples an average particle diameter may include a diameter of about 1 μm, about 2 μm, about 3 μm, about 4 μm, about 5 μm, about 6 μm, about 7 μm, about 8 μm, about 9 μm, about 10 μm, or ranges between any two of these values including endpoints.

### EXAMPLES

### Example 1

### Illustrative Compositions of Polymeric Matrix Materials and Biologically Active Agents

Table I presents non-limiting examples of compositions of materials prepared using SSSP or SSME using the methods and systems disclosed herein (values presented as weight percent of a total combination).

TABLE I

| | Material | | | | | | |
|---|---|---|---|---|---|---|---|
| | | | | | | Post- | |
| | | | | | | Consumer | Clay |
| | Polyolefin | Polyester | Polyurethane | Graphite | Cellulose | Plastic | filler |
| | (wt %) | (wt %) | (wt %) | (wt %) | (wt %) | (wt %) | (wt %) |
| Sample 1 | 89 | 0 | 0 | 1 | 0 | 0 | 10 |
| Sample 2 | 89 | 0 | 0 | 0 | 1 | 0 | 10 |
| Sample 3 | 89 | 0 | 0 | 0 | 0 | 1 | 10 |
| Sample 4 | 0 | 89 | 0 | 1 | 0 | 0 | 10 |
| Sample 5 | 0 | 89 | 0 | 0 | 1 | 0 | 10 |
| Sample 6 | 0 | 89 | 0 | 0 | 0 | 1 | 10 |
| Sample 7 | 0 | 0 | 74 | 1 | 0 | 0 | 25 |
| Sample 8 | 0 | 0 | 74 | 0 | 1 | 0 | 25 |
| Sample 9 | 0 | 0 | 74 | 0 | 0 | 1 | 25 |
| Sample 10 | 99.97 | 0 | 0 | 0.01 | 0.01 | 0.01 | 0 |
| Sample 11 | 0 | 99.97 | 0 | 0.01 | 0.01 | 0.01 | 0 |
| Sample 12 | 0 | 0 | 99.97 | 0.01 | 0.01 | 0.01 | 0 |
| Sample 13 | 0 | 0 | 65 | 3 | 2 | 0 | 30 |
| Sample 14 | 0 | 0 | 65 | 0 | 3 | 2 | 30 |
| Sample 15 | 0 | 0 | 60 | 0 | 25 | 0 | 15 |

### Example 2

### Illustrative Methods of and Systems for Fabricating Compositions of Polymeric Matrix Materials and Biologically Active Agents

Solid-State Shear Pulverization (SSSP) and Solid-state/melt extrusion (SSME) was performed using an intermeshing, co-rotating twin screw extruder with a diameter (D) of 25 mm and a length to diameter ratio (L/D) of 34. The barrel temperature setting was customized to create three distinct zones along the length of the barrel. The screws are modular in nature and designed as a combination of spiral conveying and bilobe kneading/pulverization elements. For the SSSP apparatus, all of the barrels are continuously cooled by recirculating ethylene glycol/water (60/40 vol/vol) mixture maintained at −2° C. by a chiller. The barrel section with several kneading elements in the upstream portion of the screws is termed the mixing zone. A conveying zone follows the mixing zone to cool the deformed material before intense pulverization takes place downstream in the pulverization zone.

For the SSME apparatus, the barrel temperature setting was customized to create three distinct zones along the length of the barrel. Zone 1, spanning the beginning length of L/D=16, was designed for solid-state pulverization; this portion of the barrel was continuously cooled at −12° C. by circulating ethylene glycol/water mixture from a chiller. Subsequent Zone 2 (L/D=6) is an intermediate barrel section set at 21° C., where the materials transition from the solid-state to the melt-state. Finally, Zone 3 (L/D=12) is the melt extrusion zone in which the barrel was heated to 204° C. by standard cartridge-type electrical heaters. The screw setting designed for this study contained spiral conveying (for L/D=8.5) and bilobe kneading (for L/D=7.5) elements in Zone 1, all spiral conveying in Zone 2, and spiral conveying (for L/D=8.3) and bilobe shearing and mixing (for L/D=3.7) elements in Zone 3. The screw rotation speed was maintained constant at 200 rpm for set ups.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated in this disclosure, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, or compositions, which can, of course, vary. It is also to be understood that the terminology used in this disclosure is for the purpose of describing particular embodiments only, and is not intended to be limiting.

With respect to the use of substantially any plural and/or singular terms in this disclosure, those having skill in the art can translate from the plural to the singular and/or from the singular to the plural as is appropriate to the context and/or application. The various singular/plural permutations may be expressly set forth in this disclosure for sake of clarity.

It will be understood by those within the art that, in general, terms used in this disclosure, and especially in the appended claims (for example, bodies of the appended claims) are generally intended as “open” terms (for example, the term “including” should be interpreted as “including but not limited to,” the term “having” should be interpreted as “having at least,” the term “includes” should be interpreted as “includes but is not limited to,” etc.). While various compositions, methods, and devices are described in terms of “comprising” various components or steps (interpreted as meaning “including, but not limited to”), the compositions, methods, and devices can also “consist essentially of” or “consist of” the various components and steps, and such terminology should be interpreted as defining essentially closed-member groups.

It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (for example, “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (for example, the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

As will be understood by one skilled in the art, for any and all purposes, such as in terms of providing a written description, all ranges disclosed in this disclosure also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed in this disclosure can be readily broken down into a lower third, middle third and upper third, etc. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. From the foregoing, it will be appreciated that various embodiments of the present disclosure have been described for purposes of illustration, and that various modifications may be made without departing from the scope and spirit of the present disclosure. Accordingly, the various embodiments disclosed are not intended to be limiting, with the true scope and spirit being indicated by the following claims.

What is claimed is:

1. An extrusion screw assembly for a solid state screw extruder, the assembly comprising:
at least one extrusion screw shaft; and
at least one extrusion screw element in mechanical communication with the at least one extrusion screw shaft,
wherein the at least one extrusion screw shaft comprises at least one extrusion shaft channel along at least a portion of a length of the at least one extrusion screw shaft, and
wherein the at least one extrusion shaft channel is configured to transfer a heat transfer medium.

2. The assembly of claim 1, wherein the solid state screw extruder is a solid-state shear pulverizer.

3. The assembly of claim 1, wherein the solid state screw extruder is a solid-state melt-extruder.

4. The assembly of claim 1, wherein the at least one extrusion screw shaft comprises a first extrusion screw shaft and a second extrusion screw shaft.

5. The assembly of claim 4, wherein a first longitudinal axis of the first extrusion screw shaft is about parallel to a second longitudinal axis of the second extrusion screw shaft.

6. The assembly of claim 1, wherein the at least one extrusion screw shaft comprises one or more of stainless steel, aluminum, iron, high carbon steel, tempered steel, and a surface-hardened metal.

7. The assembly of claim 1, wherein the at least one extrusion screw element comprises one or more of a shearing element, a transport element, a mixing element, a kneading element, and a pulverizing element.

8. The assembly of claim 1, wherein the at least one extrusion screw element comprises one or more of stainless steel, aluminum, iron, high carbon steel, tempered steel, and a surface-hardened metal.

9. The assembly of claim 1, wherein the at least one extrusion shaft channel is a linear channel.

10. The assembly of claim 1, wherein the at least one extrusion shaft channel is a helical channel.

11. The assembly of claim 1, wherein the at least one extrusion shaft channel comprises a plurality of extrusion shaft channels.

12. The assembly of claim 1, wherein the at least one extrusion shaft channel is disposed on a surface of the at least one extrusion shaft.

13. The assembly of claim 1, wherein the heat transfer medium comprises one or more of water, a glycol, an alcohol, carbon dioxide, and nitrogen.

14. The assembly of claim 1, wherein the at least one extrusion screw element comprises at least one extrusion element channel configured to receive the heat transfer medium.

15. The assembly of claim 14, wherein the at least one extrusion element channel is configured to receive the heat transfer medium from at least a portion of the at least one extrusion shaft channel.

16. The assembly of claim 1, wherein the at least one extrusion screw element comprises a plurality of extrusion screw elements and the assembly further comprises at least one gasket disposed between a first extrusion screw element and a second extrusion screw element.

17. The assembly of claim 1, further comprising a source of the heat transfer medium.

18. The assembly of claim 1, wherein the at least one extrusion shaft channel is disposed within an interior of the at least one extrusion shaft.

19. The assembly of claim 18, further comprising at least one rotary union coupled to the at least one extrusion shaft.

20. The assembly of claim 19, wherein the at least one rotary union is configured to conduct the heat transfer medium from a heat transfer medium source into the at least one extrusion shaft channel.

21. A method of controlling a temperature of a solid state screw extruder, the method comprising:
providing a screw extruder comprising:
an extrusion screw assembly comprising:
at least one extrusion screw shaft; and
at least one extrusion screw element in mechanical communication with the at least one extrusion screw shaft,
wherein the at least one extrusion screw shaft comprises at least one extrusion shaft channel along at least a portion of a length of the at least one extrusion screw shaft, and
wherein the at least one extrusion shaft channel is configured to transfer a heat transfer medium;
a source of a heat transfer medium; and
a temperature controller configured to control a temperature of the heat transfer medium;
causing the heat transfer medium to flow from the source of the heat transfer medium through the at least one extrusion shaft channel;
causing the at least one extrusion screw element to form a thermal contact with the heat transfer medium flowing through the at least one extrusion shaft channel; and
controlling, by the temperature controller, a temperature of one or more of the at least one extrusion shaft and the at least one extrusion screw element.

22. The method of claim 21, wherein the heat transfer medium comprises one or more of water, a glycol, an alcohol, carbon dioxide, and nitrogen.

23. A method of dispersing materials in a polymer composition, the method comprising:
providing a screw extruder comprising:
an extrusion screw assembly comprising:
at least one extrusion screw shaft; and
at least one extrusion screw element in mechanical communication with the at least one extrusion screw shaft,
wherein the at least one extrusion screw shaft comprises at least one extrusion shaft channel along at least a portion of a length of the at least one extrusion screw shaft, and
wherein the at least one extrusion shaft channel is configured to transfer a heat transfer medium;
a source of a heat transfer medium; and
a temperature controller configured to control a temperature of the heat transfer medium;
causing the heat transfer medium to flow from the source of the heat transfer medium through the at least one extrusion shaft channel;
causing the at least one extrusion screw element to form a thermal contact with the heat transfer medium flowing through the at least one extrusion shaft channel;
controlling, by the temperature controller, a temperature of one or more of the at least one extrusion shaft and the at least one extrusion screw element via the heat transfer medium;
introducing a polymeric mixture into the screw extruder;
solid-state shearing the polymeric mixture in an initial zone of the screw extruder to yield a dispersal material, wherein the temperature of one or more of the at least one extrusion shaft and the at least one extrusion screw element within the initial zone has a temperature less than or equal to a liquefication temperature of the polymeric mixture; and
dispensing the dispersal material from the screw extruder.

24. The method of claim 23, wherein the screw extruder is a twin extrusion screw extruder.

25. The method of claim 23, wherein controlling, by the temperature controller, a temperature of one or more of the at least one extrusion shaft and the at least one extrusion screw element comprises maintaining the temperature of one or more of the at least one extrusion shaft and the at least one extrusion screw element less than or equal to about 40° C.

26. The method of claim 23, wherein controlling, by the temperature controller, a temperature of one or more of the at least one extrusion shaft and the at least one extrusion screw element comprises maintaining the temperature of one or more of the at least one extrusion shaft and the at least one extrusion screw element at about 35° C. to about 45° C.

27. The method of claim 23, wherein the screw extruder is a continuously operating screw extruder.

28. The method of claim 23, wherein the polymeric mixture comprises one or more of a homo-polymer, a polymer blend, a combination of a polymer and a filler, and a combination of a polymer and a nanofiller.

29. The method of claim 23, wherein the liquefication temperature is a melting point of a semi-crystalline polymer.

30. The method of claim 23, wherein the liquefication temperature is a glass transition temperature of an amorphous polymer.
